(19) United States
(12) Patent Application Publication
(10) Pub. No.: US 2009/0160945 A1
(43) Pub. Date: Jun. 25, 2009

(54) Systems and Methods for Enhancing Image Quality of a Web Camera Image

(75) Inventors: Tze Fung Chung, Singapore (SG); Ben Jin Tan, Singapore (SG)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/962,450

(22) Filed: Dec. 21, 2007

(51) Int. Cl. H04N 5/225

(52) U.S. Cl. 348/207.1; 348/E05.086

(57) ABSTRACT

A method for capturing an image using a webcam is provided. The method may include receiving a request to capture an image using a webcam of an information handling system the information handling system comprising a display. In response to the request to capture an image, a flash screen may be displayed on the display, and an image is captured using the webcam.

### TECHNICAL FIELD

The present disclosure relates to web cameras, and more particularly to enhancing image quality of images taken by web cameras.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often include one or more peripheral devices. In general, a peripheral device may include an item of hardware that expands the information handling system's capability or function. Peripheral devices may include devices internal to the information handling system chassis or case, as well as devices external to the information handling system chassis or case. Peripheral devices may include, without limitation, storage devices (e.g., CD-ROM, CD-RW, CD-R, DVD-ROM, DVD-RW, DVD-R, USB storage device, tape drive, floppy disk, hard disk drive, and/or disk array controller), input devices (e.g., keyboard, pointing device, microphone, image scanner, webcam, and/or barcode reader), and/or output devices (e.g., printer, sound card, speakers, graphics card, monitor, and/or docking station).

Web-based cameras, or “webcams” may be used to capture an image (e.g., a photo) or a sequence of images (e.g., a video stream). These images may be transmitted to a requesting browser or other entity via a network (e.g., wide area network (WAN), the Internet, instant messaging network, video conferencing network, etc.).

One common drawback of webcams is the image quality of captured images, e.g., low resolution of the images. The images are often grainy, dim, and/or dull in color. This may be due to low-cost technology in typical webcams, such as a basic lens system that is not sophisticated enough to produce high quality images. Further, the environment in which the webcam is used often does not provide enough lighting. For example, webcams are typically used indoors where lighting conditions may not be optimal to produce bright, high contrast images.

### SUMMARY

In one embodiment of the disclosure, a method is provided. The method may include receiving a request to capture an image using a webcam of an information handling system the information handling system comprising a display. In response to the request to capture an image, a flash screen may be displayed on the display, and an image is captured using the webcam.

In other embodiments, an information handling system is provided. The information handling system may include a processor and a display device coupled to the processor. The processor may be configured to receive a request to capture an image. In response to receiving the request to capture an image using a webcam, the processor may be configured to cause the display device to display a flash screen to provide a flash effect for capturing the image with the webcam.

In accordance with another embodiment of the present disclosure, a program of instructions embodied in a tangible computer readable medium is provided. The program of instructions, when executed, may be configured to receive a request to capture an image using a webcam of an information handling system, the information handling system comprising a display. In response to the request to capture an image, the program of instructions, when executed, may be configured to automatically display a flash screen on the display and cause the webcam to capture the image.

Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an example information handling system including a webcam and a display device configured to produce a flash effect, in accordance with embodiments of the present disclosure;

FIG. 2 illustrates a flowchart of a method for capturing an image using a webcam and a flash effect from a display device, in accordance with embodiments of the present disclosure;

FIGS. 3A and 3B illustrate an example image captured with a webcam and a corresponding histogram of the image, respectively, according to existing systems; and

FIGS. 4A and 4B illustrate an example image captured with a web camera and a flash effect from a display device and a corresponding histogram of the image, respectively, in accordance with embodiments of the present disclosure.

### DETAILED DESCRIPTION

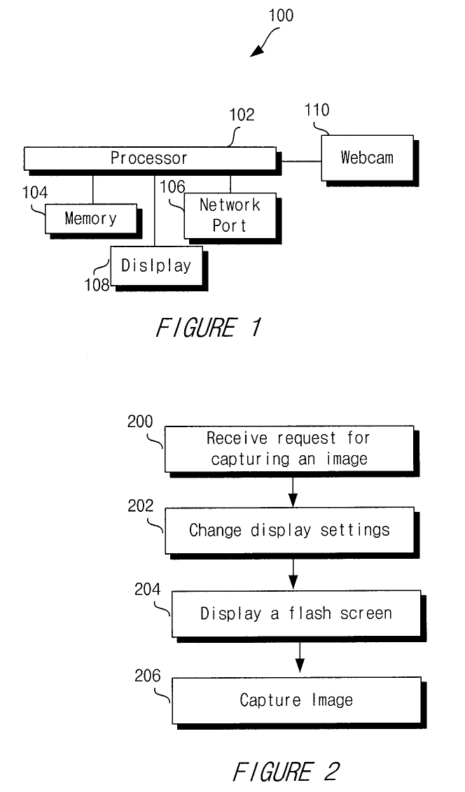

Preferred embodiments and their advantages are best understood by reference to FIGS. 1 through 4B, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and/or a video display. The information handling system may also include one or more buses operable to transmit communications between the various hardware components.

FIG. 1 illustrates a block diagram of an example information handling system 100 including a webcam 110 and a display configured to produce a flash effect, in accordance with an embodiment of the present disclosure. As shown in FIG. 1, information handling system 100 may include a processor 102, memory 104, a network port 106, a display 108, and a webcam 110.

Processor 102 may comprise any system, device, or apparatus operable to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 102 may interpret and/or execute program instructions and/or process data stored in memory 104 and/or another component of information handling system 100 and may output results, graphical user interfaces (GUIs), websites, and the like via display 108 and/or over network port 106.

Memory 104 may be coupled to processor 102 and may comprise any system, device, or apparatus operable to retain program instructions or data for a period of time. Memory 104 may be random access memory (RAM), electrically erasable programmable read-only memory (EEPROM), a PCMCIA card, flash memory, or any suitable selection and/or array of volatile or non-volatile memory that retains data after power to information handling system 100 is turned off.

Network port 106 may be any suitable system, apparatus, or device operable to serve as an interface between information handling system 100 and a network. Network port 106 may enable information handling system 100 to communicate over a network using any suitable transmission protocol and/or standard, including without limitation all transmission protocols and/or standards known in the art.

Display 108 may comprise any display device suitable for creating graphic images and/or alphanumeric characters recognizable to a user, and may include, for example, a liquid crystal display (LCD) or a cathode ray tube (CRT). In some embodiments, display 108 may be used to enhance the image quality of images captured by webcam 110. For example, display 108 may display a screen that creates a “flash effect” in connection with webcam 110 capturing an image or a series of images. The flash effect may enhance the brightness, contrast, and/or other characteristics of the captured images.

Webcam 110 may be an imaging device that may be coupled to other components of information handling system 100, e.g., via a USB port or other network port. Alternatively, webcam 110 may be integrated (e.g., built in) with another component of information handling system 100, such as display 108 for example. Webcam 110 may be configured to capture a still image such as a photograph and/or capture a sequence of images over a time, e.g., to produce a video stream.

Display 108 may display a “flash screen” in connection with webcam 110 recording or capturing an image or series of images. A “flash screen” may be any display that may produce a flash effect for capturing an image (e.g., a photo or video) using webcam 110. For example, a flash screen may display white or other bright color(s) covering all or particular portions of the screen. In some embodiments, a flash screen is a solid screen of white or other bright color.

In some embodiments, the display settings of display 108 may be manually or automatically changed such that display 108 may display the flash screen with maximum or increased brightness and/or contrast. After an image is captured by webcam 110, display 108 may revert to the previous screen display and/or previous display settings prior to the image capture.

FIG. 2 illustrates a flowchart for capturing an image using a webcam and a flash effect from a display device, in accordance with embodiments of the present disclosure. At step 200, information handling system 100 may receive from a user a request to capture an image using webcam 110. For example, the user may provide the request by using a graphical user interface displayed on display 108. For instance, the user may click a button for taking a photo or video using webcam 110.

At step 202, one or more display settings of display 108 may be manually or automatically altered. In one embodiment, the brightness setting of display 108 may be increased, e.g., to the maximum brightness setting. In the same or alternative embodiments, the contrast setting of display 108 may be increased, e.g., to the maximum contrast setting. The changes to display 108 may be made manually by a user or automatically by a software application or hardware component such as a graphics adapter associated with webcam 110. In one embodiment, the software application and/or graphics adapter may use a display data channel/command interface (DDC/CI) to adjust the setting parameters of display 108, e.g., brightness, contrast, etc.

At step 204, a flash screen may be displayed on display 108. In some embodiments, a software application executed by processor 102 of information handling system 100 may display a white or other bright-colored screen that covers substantially the entire display area or particular portions of the display area of display 108. Applications (e.g., application windows) that are currently being displayed on display 108 may be temporarily minimized or hidden behind the flash screen such that the flash screen is displayed before and/or during the image capture.

At step 206, webcam 110 may capture one or more images, e.g., a photo or a video. The image(s) may be captured wile the flash screen is displayed or just after the flash screen is displayed. The flash screen may be displayed for any suitable length of time, which may be manually or automatically determined based on various factors such as, e.g., the type of image capture (photo vs. video, for example), user settings for the flash screen duration, etc. In some embodiments, display 109 may display the flash screen over an extended period time such that multiple images or a video may be captured at step 206.

Some or all of the steps of the flowchart of FIG. 2 may be implemented using system 100 or any other system operable to implement the method. In certain embodiments, the method illustrated in FIG. 2 may be implemented partially or fully in software embodied in tangible computer readable media. As used in this disclosure, “tangible computer readable media” means any instrumentality, or aggregation of instrumentalities that may retain data and/or instructions for a period of time. Tangible computer readable media may include, without limitation, random access memory (RAM), read-only memory (ROM), electrically erasable programmable read-only memory (EEPROM), a PCMCIA card, flash memory, direct access storage (e.g., a hard disk drive or floppy disk), sequential access storage (e.g., a tape disk drive), compact disk, CD-ROM, DVD, and/or any suitable selection of volatile and/or non-volatile memory and/or a physical or virtual storage resource.

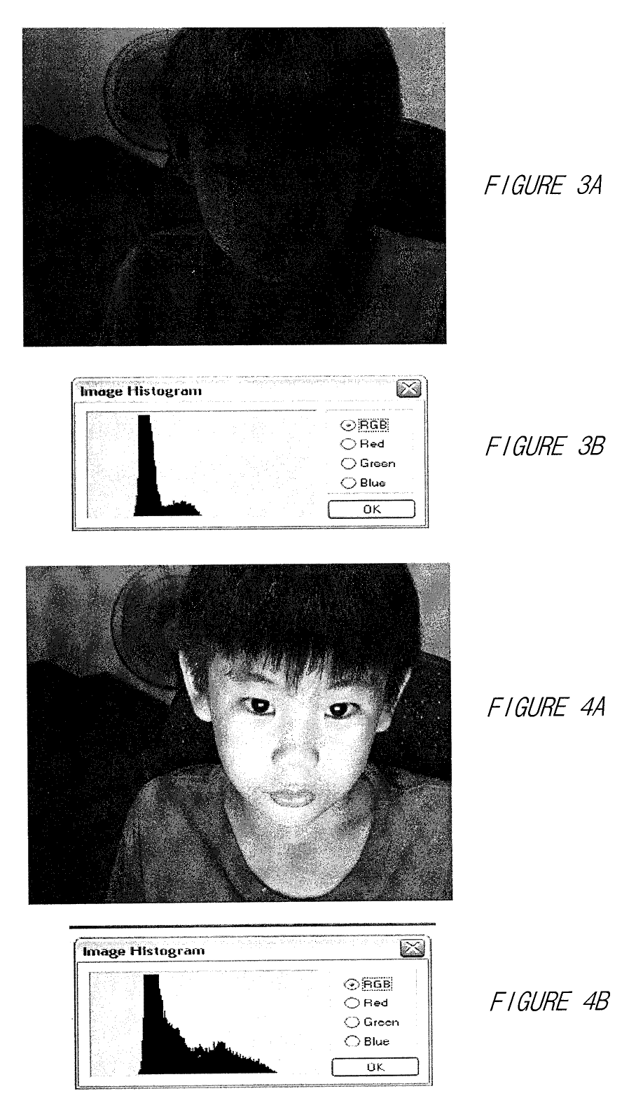

FIGS. 3A and 3B show an example image of a subject spaced 50 centimeters from a liquid crystal display (LCD) screen and a corresponding histogram of the image, respectively. The image of FIG. 3A was taken without the flash effect and illustrates a typical image quality of a webcam, which is relatively dull, grainy, and low in brightness and contrast.

FIGS. 4A and 4B show an example image of a subject and a corresponding histogram of the image, respectively, where the image was taken using a flash effect as described herein. The image was taken with the subject spaced 50 centimeters from the LCD screen and with the same photo capture settings used to take the image of FIG. 3A.

As shown, the image in FIG. 4A (with flash effect) has an improved contrast and brightness as compared to the image in FIG. 3A (no flash effect). The flash effect provided by the displaying a flash screen on the LCD screen increases the brightness and contrast of the image. This is confirmed by comparing the histograms of each image. As seen in the histograms, the range of dark tones to light tones in the histogram of FIG. 3B is less than the range shown in the histogram of FIG. 4B.

The methods and systems described herein may enhance the quality of images captured by webcams. In accordance with the present disclosure, the systems and methods disclosed herein may be technically advantageous because they may provide for an efficient, low cost solution to the webcams that are being used without having to update or upgrade the webcams.

Although the present disclosure has been described in detail, it should be understood that various changes, substitutions, and alterations can be made hereto without departing from the spirit and the scope of the invention as defined by the appended claims.

What is claimed is:

1. A method, comprising:
receiving a request to capture an image using a webcam of an information handling system, the information handling system comprising a display;
in response to the request to capture an image, displaying a flash screen on the display; and
capturing the image using the webcam.

2. The method of claim 1, further comprising automatically adjusting a brightness setting of the display in response to the received request.

3. The method of claim 1, further comprising automatically adjusting a contrast setting of the display in response to the received request to capture an image using a webcam.

4. The method of claim 1, further comprising automatically adjusting the brightness setting and contrast setting of the display in response to the received request to capture an image using a webcam.

5. The method of claim 1, wherein:
displaying includes a display area; and
displaying the flash screen comprises displaying the flash screen in substantially the entire display area of the display to capture an image using a webcam.

6. The method of claim 1, wherein:
displaying includes a display area; and
displaying the flash screen comprises displaying the flash screen in a portion of the display area of the display.

7. The method of claim 1, wherein displaying the flash screen comprises displaying a bright-colored screen.

8. The method of claim 7, the wherein bright-colored screen comprises a white-colored screen

9. The method of claim 1, wherein capturing the image comprises capturing the image while displaying the flash screen.

10. An information handling system, comprising:
a processor; and
a display device coupled to the processor;
wherein the processor is configured to:
receive a request to capture an image; and
in response to receiving the request to capture an image using a webcam, cause the display device to display a flash screen to provide a flash effect for capturing the image with the webcam.

11. The information handling system of claim 10, wherein the display device is a liquid crystal display.

12. The information handling system of claim 10, wherein the processor is further configured to automatically adjust a brightness setting or a contrast setting of the display device in response to receiving a request to capture an image using a webcam.

13. The information handling system of claim 12, wherein the flash screen comprises a bright-colored screen.

14. The information handling system of claim 10, wherein:
the display device includes a display area; and
the display device is configured to display the flash screen in substantially the entire display area of the display device.

15. The information handling system of claim 10, wherein:
the display device includes a display area; and
the display device is configured to display the flash screen in a portion of the display area of the display device.

16. A program of instructions embodied in a tangible computer readable medium and, when executed, configured to:
receive a request to capture an image using a webcam of an information handling system, the information handling system comprising a display;
in response to the request to capture an image, automatically display a flash screen on the display; and
cause the webcam to capture the image.

17. The program of instructions of claim 16, further configured to adjust at least one of a brightness setting and a contrast setting for the display in response to the received request to capture an image using a webcam.

18. The program of instructions of claim 16, wherein displaying the flash screen comprises displaying a bright-colored screen.

19. The program of instructions of claim 18, wherein displaying a bright-colored screen comprises displaying a white-colored screen.

20. The program of instructions of claim 16, wherein displaying the flash screen comprises displaying a bright-colored screen covering an entire display area of the display device.
